(19) United States
(12) Patent Application Publication
(10) Pub. No.: US 2026/0197512 A1
(43) Pub. Date: Jul. 9, 2026

(54) VOLUMETRIC VIDEO CAPTURE OF ROADSIDE INCIDENT USING AUTONOMOUS VEHICLE NETWORK

(71) Applicant: International Business Machines Corporation, Armonk, NY (US)

(72) Inventors: Carolina Garcia Delgado, Zapopan (MX); Sarbajit Kumar Rakshit, Kolkata (IN); JAZMIN RODRIGUEZ AGUILERA, Zapopan (MX); Jeremy R. Fox, Georgetown, TX (US)

(21) Appl. No.: 19/008,876

(22) Filed: Jan. 3, 2025

(51) Int. Cl. H04N 21/258; G06V 20/58; H04W 4/40

(52) U.S. Cl. CPC H04N 21/25841; G06V 20/58; H04W 4/40

(57) ABSTRACT

According to one embodiment, a method, computer system, and computer program product for capturing volumetric video of a roadside incident is provided. The embodiment may include detecting a roadside event with video capturing equipment of an autonomous vehicle. The embodiment may include determining that the roadside event has a viral potential above a threshold value. The embodiment may include capturing volumetric media of the roadside event using the video capturing equipment of the autonomous vehicle. The embodiment may include publishing the volumetric media to an online media portal.

### BACKGROUND

The present invention relates generally to the field of computing, and more particularly to digital capture of volumetric video.

Volumetric video (i.e., volumetric capture) refers to a technology that captures a three-dimensional (3D) representation of a person or object in a real-world space. It involves the use of multiple cameras or depth sensors to capture a subject from different angles and create a volumetric representation. This representation can be viewed from any perspective, allowing users to experience captured video content in a more immersive and interactive way. While traditional video recordings are captured from a fixed perspective and viewed on a two-dimensional (2D) screen, volumetric video captures a scene from multiple viewpoints using an array of cameras or depth sensors placed around the subject. These cameras capture the scene or object from different angles simultaneously, thus creating a 3D representation. Volumetric video has various applications across industries such as entertainment media, gaming, virtual reality (VR), augmented reality (AR), teleconferencing, and education. It enables realistic virtual experiences where users can explore and interact with 3D video content in a more natural way.

### SUMMARY

According to one embodiment, a method, computer system, and computer program product for capturing volumetric video of a roadside incident is provided. The embodiment may include detecting a roadside event with video capturing equipment of an autonomous vehicle. The embodiment may include determining that the roadside event has a viral potential above a threshold value. The embodiment may include capturing volumetric media of the roadside event using the video capturing equipment of the autonomous vehicle. The embodiment may include publishing the volumetric media to an online media portal.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computer environment according to at least one embodiment.

FIG. 2 illustrates an operational flowchart for collaboratively capturing volumetric video of a roadside incident via a roadside volumetric video capture process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to volumetric video capture. The following described exemplary embodiments provide a system, method, and program product to, among other things, capture and share volumetric video of an occurrence or scene via a network of one or more traveling autonomous vehicles. Therefore, the present embodiment has the capacity to improve the technical field of volumetric video capture by dynamically identifying, in real-time, a roadside event of interest and sharing captured volumetric video of the event, thus alerting other nearby vehicles/motorists of the roadside event and enabling others to visualize the captured volumetric video of the roadside event.

As previously described, volumetric video (i.e., volumetric capture) refers to a technology that captures a 3D representation of a person or object in a real-world space. It involves the use of multiple cameras or depth sensors to capture a subject from different angles and create a volumetric representation. This representation can be viewed from any perspective, allowing users to experience captured video content in a more immersive and interactive way. While traditional video recordings are captured from a fixed perspective and viewed on a 2D screen, volumetric video captures a scene from multiple viewpoints using an array of cameras or depth sensors placed around the subject. These cameras capture the person or object from different angles simultaneously, thus creating a 3D representation. Volumetric video has various applications across industries such as entertainment, gaming, VR, AR, teleconferencing, and education. It enables realistic virtual experiences where users can explore and interact with 3D video content in a more natural way.

While travelling in a vehicle, various types of incidents may be observed on or near the roadside. Passengers travelling in the vehicle may be interested in capturing video of an observed incident, moreover captured video of the observed incident may have potential to become viral if shared on the internet. However, as the vehicle is moving, the position and direction of the vehicle relative to an observed incident will change, thus making it challenging to capture video of the incident from the vehicle. Additionally, as the observed incident may not last for a long duration, passengers in one or more following vehicles may not be able to witness or visualize the incident. It may therefore be imperative to have a roadside volumetric video capture system in place to identify an event occurring on or near a road via a vehicle travelling the road, to coordinate vehicle-to-everything (V2X) communication among the vehicle and one or more other vehicles travelling the road in order to collaboratively capture geo-tagged volumetric video of the event from various angles while traveling the road, and to share the geo-tagged volumetric video so that the event can be visualized by others. Thus, embodiments of the present invention may be advantageous to, among other things, form a vehicle-to-vehicle network of a plurality autonomous vehicles in response to a detected incident on a roadside, coordinate data communication and processing among a network of autonomous vehicles, consider potential viral sharing of a detected roadside event based on historical data (e.g. data of a similar event), receive a media creation request from a remote server for capturing volumetric media of a detected roadside incident, geo-tag and publish volumetric media of an incident collaboratively captured by one or more autonomous vehicles, receive a location of a roadside incident relative to one or more autonomous vehicles, capture volumetric media of a roadside incident from multiple angles by one or more autonomous vehicles, allow other vehicles to visualize captured volumetric media of a detected event in an augmented reality (AR) interface of a respective autonomous vehicle while traveling through a same location of the detected event at a same or later time, analyze historical data to predict a detected incident's duration, deploy one or more autonomous vehicles to capture volumetric video of a detected event, and control respective driving operation and video capture behavior of one or more autonomous vehicles participating on collaborative volumetric video capture of a detected event. The present invention does not require that all advantages need to be incorporated into every embodiment of the invention.

According to at least one embodiment, a roadside volumetric video capture program may receive data of an incident occurring on or near a road. The data may be received from a first autonomous vehicle traveling on the road. The autonomous vehicle may be equipped with various sensors (e.g., digital cameras, lidar, radar, temperature sensors, moisture sensors, microphones) configured to automatically capture data of detected events within the surrounding environment of the autonomous vehicle. The roadside volumetric video capture program may determine that additional data of the incident should be captured and coordinate vehicle-to-vehicle (V2V) communication among the first autonomous vehicle and one or more other available autonomous vehicles, following the first autonomous vehicle, to establish a network of autonomous vehicles. Furthermore, the roadside volumetric video capture program may instruct the network of autonomous vehicles to collaboratively capture data, including digital video, of the incident. According to at least one embodiment, the roadside volumetric video capture program may receive respective video feeds from the network of autonomous vehicles and process the video feeds to create volumetric video media of the incident. The roadside volumetric video capture program may then publish the volumetric video of the incident to the network of autonomous vehicles and/or to online media services.

According to at least one other embodiment, the roadside volumetric video capture program may deploy additional autonomous vehicles to the location of the detected incident to participate in the collaborative volumetric video capture of the incident.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to mitigate current or predicted camera/sensor failures while capturing volumetric video of a scene.

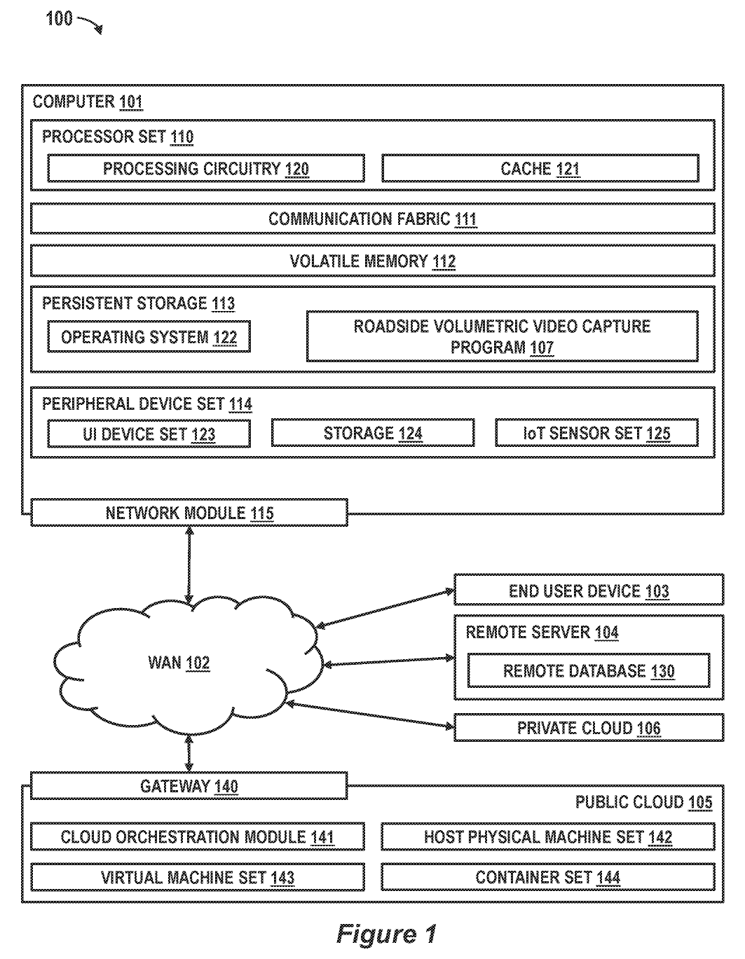

Referring to FIG. 1, an exemplary computing environment 100 is depicted, according to at least one embodiment. Computing environment 100 contains an example of an environment for the execution of at least some of the computer code involved in performing the inventive methods, such as roadside volumetric video capture (RVVC) program 107. In addition to RVVC program 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and RVVC program 107), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smart watch or other wearable computer, mainframe computer, quantum computer or any other form of computer or mobile device now known or to be developed in the future that is capable of running a program and accessing a network or querying a database, such as remote database 130. Additionally, computer 101 may be any other form of computer or mobile device now known or to be developed in the future that is AR/VR-enabled. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in RVVC program 107 within persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in RVVC program 107 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as smart glasses, smart watches, AR/VR-enabled headsets, and wearable cameras), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, another sensor may be a motion detector, another sensor may be a global positioning system (GPS) receiver, and yet another sensor may be a digital image capture device (e.g., a camera) capable of capturing and transmitting one or more still digital images or a stream of digital images (e.g., digital video).

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a client of an enterprise that operates computer 101), and may take any of the forms (and possess any of the technical capabilities) discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on. According to at least one other embodiment, in addition to taking any of the forms discussed above with computer 101, EUD 103 may further be an IoT-enabled autonomous vehicle or other IoT-enabled device (e.g., a fixed camera, sensor) capable of capturing volumetric video and other data of a scene, connecting to computer 101 via WAN 102 and network module 115, and capable of receiving instructions from RVVC program 107. In an embodiment where EUD 103 is an IoT-enabled device, EUD 103 may be mounted to a mobile platform (e.g., an unmanned aerial or wheeled vehicle) capable of performing movement along an x, y, and z axis. Furthermore, where EUD 103 is an IoT-enabled mobile or fixed digital image capture device, EUD 103 may also be capable of rotational movement (i.e., pitch, yaw, and roll). Although only a single EUD 103 is depicted, computing environment 100 may include a plurality of EUDs 103 (e.g., a plurality of IoT-enabled autonomous vehicles and/or IoT-enabled devices for volumetric capture).

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

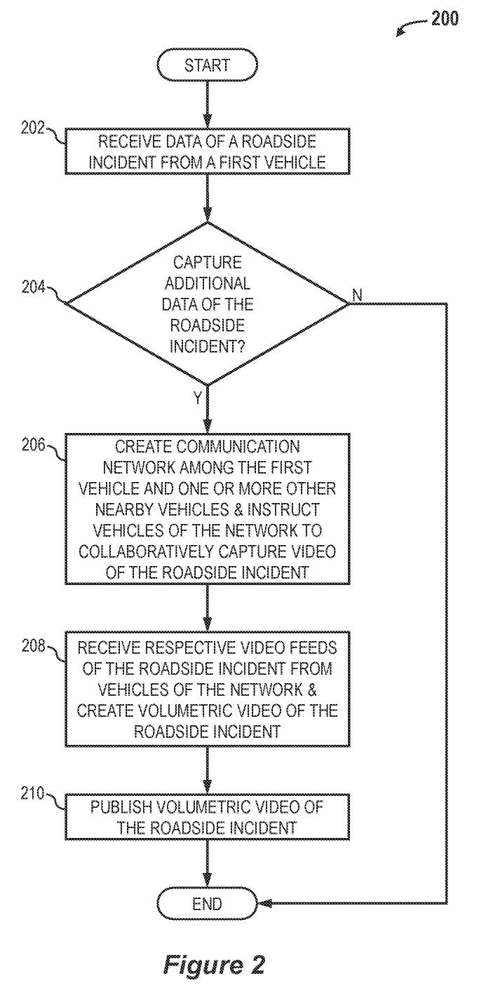

The RVVC program 107 may be a program capable of forming a vehicle-to-vehicle network of a plurality autonomous vehicles in response to a detected incident on a roadside, coordinating data communication and processing among a network of autonomous vehicles, considering potential viral sharing of a detected roadside event based on historical data (e.g. data of a similar event), receiving a media creation request from a remote server for capturing volumetric media of a detected roadside incident, geo-tagging and publishing volumetric media of an incident collaboratively captured by one or more autonomous vehicles, receiving a location of a roadside incident relative to one or more autonomous vehicles, capturing volumetric media of a roadside incident from multiple angles by one or more autonomous vehicles, enabling other vehicles to visualize captured volumetric media of a detected event in an augmented reality (AR) interface of a respective autonomous vehicle while traveling through a same location of the detected event at a same or later time, analyzing historical data to predict a detected incident's duration, deploying one or more autonomous vehicles to capture volumetric video of a detected event, and controlling respective driving operation and video capture behavior of one or more autonomous vehicles participating on collaborative volumetric video capture of a detected event. In at least one embodiment, RVVC program 107 may require a user to opt-in to system usage upon opening or installation of RVVC program 107, or upon traveling in a vehicle configured with RVVC program 107. Notwithstanding depiction in computer 101, RVVC program 107 may be stored in and/or executed by, individually or in any combination, end user device 103, remote server 104, public cloud 105, and private cloud 106 so that functionality may be separated among the devices. The roadside volumetric video capture method is explained in further detail below with respect to FIG. 2.

Referring now to FIG. 2, an operational flowchart for collaboratively capturing volumetric video of a roadside incident via a roadside volumetric video capture process 200 is depicted according to at least one embodiment. At 202, RVVC program 107 receives data of a captured roadside incident from a first autonomous vehicle participating in media capture via RVVC program 107. According to at least one embodiment, the roadside incident may be occurring on or near a road being traveled by the first autonomous vehicle. Each autonomous vehicle may have different types of sensors (e.g., global positioning sensors, multi-directional cameras, lidar, radar, microphones, infrared sensors, thermal imaging sensors, and possibly other specialized sensors to capture distance measurements and object velocities) mounted on the exterior of the vehicle, and while the autonomous vehicle is traveling on the road surrounding roadside information may be captured by the autonomous vehicle. These sensors may capture data about the vehicle's surroundings, including geographic location data and visual data (e.g., digital images and digital video). According to at least one embodiment, the sensors may be preconfigured (e.g., during an initialization process of RVVC program 107) to periodically or continuously capture data of the vehicle’s surroundings. The sensors may also be preconfigured to capture data of the vehicle’s surroundings in response to detection of one or more pre-defined events (e.g., presence of an emergency vehicle, an accident, an animal, and/or adverse driving conditions) occurring within the vehicle’s surroundings. Furthermore, according to at least one embodiment, RVVC program 107 may geo-tag the content (i.e., the captured data) received from the vehicle with information of its geographic location.

According to at least one embodiment, the sensors may be configured to capture data of the vehicle’s surroundings in response to receiving a media creation request from an instance of RVVC program 107 executing on a remote server or from an internet media service provider in communication with RVVC program 107. A media creation request may specify one or more types of roadside media (i.e., incidents) to be captured via sensors of the vehicle. A media creation request may also include a description and criticality of the incident and may also be based on factors such as geographic location, time, and weather conditions. Media creation requests of an internet media service provider may be published to RVVC program 107 against different geo-location ranges.

According to at least one embodiment, RVVC program 107 may process received captured data using computer vision analysis techniques and algorithms to extract relevant information. Computer vision techniques (e.g., object detection, segmentation, tracking) may extract features from the captured images or video frames, such as edges, colors, shapes, and patterns. These features may be used to identify objects and potential incidents on or near the road. By utilizing machine learning algorithms (e.g., a convolutional neural network (CNN)) trained on large datasets of labeled images or video frames, RVVC program 107 may detect and classify objects in the captured images or video frames, such as pedestrians, vehicles, traffic signs, and other relevant objects, as well as identify a context of the roadside incident. The detected objects/scenario (a set of objects) may be further analyzed to identify potential incidents or anomalies on or near the road such as accidents, road hazards, obstructions, or other unexpected situations. Once objects are detected, RVVC program 107 may compare the observed scene with data of expected or normal scenarios. Any deviations or anomalies from expected conditions can indicate a roadside incident. Machine learning algorithms trained on large datasets of labelled images or video frames may enable RVVC program 107 to learn and recognize patterns associated with different types of roadside incidents. For example, sudden changes in object behavior, unexpected object configurations, or irregular movements may be potential indicators of incidents. Additionally, RVVC program 107 may also evaluate historical data of similar incidents to predict a time duration of an identified incident. According to at least one other embodiment, the autonomous vehicle may, at the direction of RVVC program 107, act as an edge device to process the captured data using computer vision analysis techniques and algorithms prior to transmitting data of the roadside incident to an instance of RVVC program 107 executing on a remote server. According to at least one other embodiment, in response to the detected incident, RVVC program 107 may notify a vehicle occupant (e.g., a driver and/or passenger) via an alert on a display of the vehicle and may also prompt the occupant to continue participation in media capture via RVVC program 107.

Next, at 204, RVVC program 107 determines whether additional data of the roadside incident should be captured. According to at least one embodiment, RVVC program 107 may utilize output from the computer vision analysis performed above in making this determination. For example, RVVC program 107 may evaluate whether the context of the roadside incident is aligned with (i.e., similar to) current viral media trends, events, or culturally popular topics. As such, RVVC program 107 may consider patterns, characteristics, and metadata (e.g., descriptive tags, labels, number of views, location) of current and historically captured viral social media trends, news, cultural events, and data of past similar incidents to identify insights such as common contexts, formats, or strategies among them, and use those insights to assess the viral potential of the roadside incident (i.e., the likelihood that media content of the roadside incident may become widely shared and gain wide attention across the internet). For instance, RVVC program 107 may assess the viral potential of the roadside incident by comparing the respective metadata of current and historically captured viral social media trends, news, and cultural events with metadata of the roadside incident which may also be received at step 202 and may include information such as descriptive tags, labels, and attributes of the roadside incident. Where the comparison indicates a similarity above a threshold, RVVC program 107 may determine a high viral potential of the roadside incident. RVVC program 107 may also determine that additional data of the roadside incident should be captured where the context of the roadside incident is similar to a current viral media trend and/or where the viral potential of the roadside incident is above a threshold value. Additionally, and/or alternatively, RVVC program 107 may, in another embodiment, validate whether the captured roadside incident is of a type that matches requirements of a media creation request. As different media service providers may define requirements of different types of roadside media/incidents, such requirements may be varied from time to time, location to location, or incident to incident. Consequently, while vehicles are traveling, RVVC program 107 may evaluate a captured roadside incident against defined media creation request requirements and accordingly instruct vehicles to continue capture the incident where appropriate. RVVC program 107 may determine that additional data of the roadside incident should be captured where the captured roadside incident is of a type that matches a media creation request. According to at least one further embodiment, in determining whether additional data of the roadside incident should be captured, RVVC program 107 may additionally consider any strong emotions (e.g., surprise, awe, amusement) identified during the computer vision analysis of the captured visual data of the incident. In response to determining that additional data of the roadside incident should be captured (step 204, “Y” branch), the roadside volumetric video capture process 200 may proceed to step 206. In response to determining that additional data of the roadside incident should not be captured (step 204, “N” branch), the roadside volumetric video capture process 200 may terminate.

At 206, in response to determining that additional data of the roadside incident should be captured, RVVC program 107 creates a communication network among the first autonomous vehicle and one or more other nearby autonomous vehicles also participating in media capture via RVVC program 107. Furthermore, RVVC program 107 instructs vehicles of the created network to collaboratively capture data, including digital video, of the roadside incident. According to at least one embodiment, the nearby vehicles may be other autonomous vehicles following the first autonomous vehicle along the same road. Once the roadside incident is detected by the first autonomous vehicle, RVVC program 107 may initiate vehicle-to-everything (V2X) computation among the vehicles of the network to facilitate collaborative capture of volumetric video of the incident via the vehicles and to facilitate communication among the vehicles and any surrounding IoT-enabled infrastructure. The vehicles may use cellular networks, dedicated short-range communication (DSRC), or emerging technologies like 5G. According to at least one embodiment, each of the participating vehicles, based on their respective real-time positions, may track and capture data of the detected incident from different viewpoints and directions simultaneously. For example, each vehicle may provide a respectively measured distance to the detected incident and identified direction of the detected incident. The V2X communication enables vehicles to exchange respectively captured data with other vehicles, roadside infrastructure, and/or a central server hosting RVVC program 107. RVVC program 107 may evaluate current geo-locations of the vehicles, measured distances, and identified directions to extrapolate geo-location coordinate of the detected incident.

Furthermore, for each vehicle of the network, RVVC program 107 may evaluate the spatial relationship between a geo-location coordinate of a vehicle and the geo-location coordinate of the detected incident to calculate the locus of two points. The geo-location coordinates of the vehicle and the detected incident may each be static, or one may be moving while the other is static, or both may be moving. As such, calculation of the locus between two points may be based a type of the spatial relationship between the geo-location coordinates of the vehicle and the detected incident. For example, a linear relationship may exist between the geo-location coordinates of the vehicle and the detected incident, a geometric relationship may exist between the geo-location coordinates, or parametric equations may be used to describe the locus between the geo-location coordinates. Where the geo-location coordinate of a vehicle is moving and geo-location coordinate of the detected incident is static, the captured volume of video may encompass the boundary between the locus of the two points (e.g., the environment between the vehicle and detected incident). Moreover, where the geo-location coordinates of the vehicle and the detected incident are both moving, the captured volume of video (i.e., the boundary between the locus of the two points ) may shift along with the movement of the two points. According to at least one embodiment, as the locus are calculated, RVVC program 107 may, via the V2X communication, instruct the vehicles to configure and align their respective cameras and synchronize their actions to coordinate video capture of the detected incident in a collaborative manner and in accordance with requirements (e.g., image quality, zoom level) of a received media creation request. According to at least one embodiment, if a focus distance to the detected incident changes (e.g., a change in zoom level), the entire volume of video (i.e., video encompassing the entire physical space) between a vehicle and the detected incident will not be captured; only the volume of video required by the focus distance may be captured via V2X collaboration. According to at least one other embodiment, a spatial relationship between the geo-location coordinate of the vehicle and the geo-location coordinate of the detected incident may consider three dimensional (3-D) movements of either the vehicle or the detected incident, or both.

According to at least one other embodiment, in instructing the collaborative video capture of the detected incident, RVVC program 107 may control the driving operation of one or more of the participating vehicles. For example, the profile (e.g., the path) of the road being traveled by the vehicles may be known to RVVC program 107 and may be the locus of vehicle movement. As such, RVVC program 107 may adjust the steering and speed of one or more vehicles to arrange them in manner more conducive to the collaborative video capture of the detected incident (e.g., arranging the vehicles from two lane travel to single lane travel in order to capture data of a roadside incident). According to yet another embodiment, RVVC program 107 may deploy one or more additional autonomous vehicles to capture data of the detected incident. Based on a predicted time duration of the incident, a current state of the incident, and speeds of vehicles already capturing data of the incident, RVVC program 107 may allocate additional vehicles, with appropriate equipment and interfaces, to positions along the route of the incident to participate in the collaborative video capture. A frequency of additional deployments may be based on a length of time a vehicle can provide coverage (i.e., data capture) of the incident.

Further, at 206, as requirements of a media creation request may change in real-time, RVVC program 107 may, according to at least one embodiment, dynamically adjust video capture behavior of participating vehicles of the network according to varying criteria such as time, location, and incident type; thereby optimizing the vehicles' data capture response to diverse media creation needs.

At 208, RVVC program 107 receives respective video feeds of the roadside incident from vehicles of the network and processes the video feeds to create a comprehensive volumetric video representation of the detected roadside incident. According to at least one embodiment, the captured volumetric video can be further processed, analyzed, or used for applications such as virtual reality (VR) experiences, augmented reality (AR) applications, training simulations, or data analysis for research or situational awareness purposes. Furthermore, according to at least one other embodiment, RVVC program 107 may continuously evaluate whether continued video capture of the detected incident is still required by the media requestor. Where continued video capture of the detected incident is no longer required, RVVC program 107 may instruct participating vehicles to terminate the collaborative video capture and the V2X computation.

Next, at 210, RVVC program 107 publishes the comprehensive volumetric video representation of the roadside incident. According to at least one embodiment, RVVC program 107 may publish the geo-tagged volumetric video representation of the detected roadside incident to an online media portal for sharing with, and viewing by, other people. According to at least one other embodiment, each video feed received by RVVC program 107, and contributing to the comprehensive volumetric video representation, may have respective metadata including a unique identifier (e.g. an occupant user ID), a geo-tag which maps with the geographic location of video capture, and an amount of captured video. RVVC program 107 may identify respective video feeds captured by participating vehicles of the network via their unique identifier and provide them with royalties (e.g., contend creator points, payments) based on their respective number of video views and/or their respective amounts of video capture. According to at least one further embodiment, RVVC program 107 may share the geo-tagged volumetric video representation of the detected roadside incident with other vehicles traveling through the same geographic location of the incident while the incident is occurring or after the incident has concluded. For example, RVVC program 107 may prompt a passenger of another vehicle to allow the program to share the volumetric video representation via an AR interface of their vehicle. RVVC program 107 may overlay the volumetric video representation onto the same physical surroundings when visualized via the AR interface of the vehicle. Such a visualization may allow an occupant a different perspective of the incident.

It may be appreciated that FIG. 2 provides only an illustration of one implementation and does not imply any limitations with regard to how different embodiments may be implemented. Many modifications to the depicted environments may be made based on design and implementation requirements.

The following use cases may provide additional examples of the implementations and outputs of RVVC program 107:

Use Case 1 – Julio is a professional private car service driver. During his daily commute to work, Julio encountered a peculiar and unusual incident that involved an ostrich and a zebra crossing the street, he wanted to get a video of this event. He was tempted to take a video clip of this pandemonium, but his car was in motion and made it challenging to record the incident with good quality video. As he is travelling, Julio's car has been enabled for participation with RVVC program 107. RVVC program 107 detects the incident, and Julio is given the option of participating in the capture of video footage to document the incident. RVVC program 107 proceeds to initiate a V2X network between other cars located in the vicinity of the incident. All these cars then join to collaboratively capture volumetric video of the roadside incident dynamically in real-time. After the completion of the video capture process, the volumetric clip is geo-tagged and posted on a media upload site by RVVC program 107. Julio receives compensation for contributing to the capture in the form of royalty from viewings of the volumetric clip that he had his car film for him.

Use Case 2 – A transportation enterprise teaches defensive driving to their driving personnel to reduce accidents. The enterprise publishes a media creation request which defines roads types, incidents, vehicles, times, and road environments of interest for training. RVVC program 107 identifies volumetric video that matches enterprise’s media creation request and recreates road incidents conditions within a VR environment so the drivers can practice on it.

The descriptions of the various embodiments and use cases of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
detecting a roadside event with video capturing equipment of an autonomous vehicle;
determining that the roadside event has a viral potential above a threshold value;
capturing volumetric media of the roadside event using the video capturing equipment of the autonomous vehicle; and
publishing the volumetric media to an online media portal.

2. The method of claim 1, wherein determining that the roadside event has a viral potential above a threshold value comprises a determination based on historical data of events similar to the roadside event.

3. The method of claim 1, further comprising:
directly sharing the volumetric media with nearby vehicles for viewing within the nearby vehicles via respective augmented reality (AR) interfaces of the nearby vehicles.

4. The method of claim 1, further comprising:
geo-tagging the volumetric media as taking place at a geo-location of the roadside event; and
sharing the volumetric media with vehicles that pass the geo-location at a later time.

5. The method of claim 4, further comprising:
deploying one or more other autonomous vehicles to the geo-location of the roadside event;
creating a vehicle-to-everything (V2X) communication network among the autonomous vehicle and the one or more other autonomous vehicles; and
instructing the autonomous vehicle and the one or more other autonomous vehicles to collaboratively capture volumetric media of the roadside event via the V2X communication network.

6. The method of claim 5, further comprising:
controlling driving operation and video capture behavior of the autonomous vehicle and the one or more other autonomous vehicles.

7. The method of claim 1, further comprising:
receiving a media creation request from a remote server for capturing volumetric media of a detected roadside incident.

8. A computer system, the computer system comprising:
one or more processors, one or more computer readable memories, one or more computer readable storage medium, and program instructions stored on at least one of the one or more computer readable storage medium for execution by at least one of the one or more processors via at least one of the one or more memories, wherein the computer system is capable of performing a method comprising:
detecting a roadside event with video capturing equipment of an autonomous vehicle;
determining that the roadside event has a viral potential above a threshold value;
capturing volumetric media of the roadside event using the video capturing equipment of the autonomous vehicle; and
publishing the volumetric media to an online media portal.

9. The computer system of claim 8, wherein determining that the roadside event has a viral potential above a threshold value comprises a determination based on historical data of events similar to the roadside event.

10. The computer system of claim 8, the method further comprising:
directly sharing the volumetric media with nearby vehicles for viewing within the nearby vehicles via respective augmented reality (AR) interfaces of the nearby vehicles.

11. The computer system of claim 8, the method further comprising:
geo-tagging the volumetric media as taking place at a geo-location of the roadside event; and
sharing the volumetric media with vehicles that pass the geo-location at a later time.

12. The computer system of claim 11, the method further comprising:
deploying one or more other autonomous vehicles to the geo-location of the roadside event;
creating a vehicle-to-everything (V2X) communication network among the autonomous vehicle and the one or more other autonomous vehicles; and
instructing the autonomous vehicle and the one or more other autonomous vehicles to collaboratively capture volumetric media of the roadside event via the V2X communication network.

13. The computer system of claim 12, the method further comprising:
controlling driving operation and video capture behavior of the autonomous vehicle and the one or more other autonomous vehicles.

14. The computer system of claim 8, the method further comprising:
receiving a media creation request from a remote server for capturing volumetric media of a detected roadside incident.

15. A computer program product, the computer program product comprising:
one or more computer readable storage medium and program instructions stored on at least one of the one or more computer readable storage medium, the program instructions executable by a processor capable of performing a method, the method comprising:
detecting a roadside event with video capturing equipment of an autonomous vehicle;
determining that the roadside event has a viral potential above a threshold value;
capturing volumetric media of the roadside event using the video capturing equipment of the autonomous vehicle; and
publishing the volumetric media to an online media portal.

16. The computer program product of claim 15, wherein determining that the roadside event has a viral potential above a threshold value comprises a determination based on historical data of events similar to the roadside event.

17. The computer program product of claim 15, the method further comprising:
directly sharing the volumetric media with nearby vehicles for viewing within the nearby vehicles via respective augmented reality (AR) interfaces of the nearby vehicles.

18. The computer program product of claim 15, the method further comprising:
geo-tagging the volumetric media as taking place at a geo-location of the roadside event; and
sharing the volumetric media with vehicles that pass the geo-location at a later time.

19. The computer program product of claim 18, the method further comprising:
deploying one or more other autonomous vehicles to the geo-location of the roadside event;
creating a vehicle-to-everything (V2X) communication network among the autonomous vehicle and the one or more other autonomous vehicles; and
instructing the autonomous vehicle and the one or more other autonomous vehicles to collaboratively capture volumetric media of the roadside event via the V2X communication network.

20. The computer program product of claim 19, the method further comprising:
controlling driving operation and video capture behavior of the autonomous vehicle and the one or more other autonomous vehicles.
